(19) United States
(12) Patent Application Publication
(10) Pub. No.: US 2001/0011998 A1
(43) Pub. Date: Aug. 9, 2001

(54) EMBEDDED KEYBOARD POINTING DEVICE WITH KEYBOARD UNIT AND INFORMATION PROCESSING APPARATUS

(76) Inventors: HIROAKI AGATA, YOKOHAMA-SH, (JP); TOMOYUKI TAKAHASHI, FUJISAWA-SHI (JP); SATORU YAMADA, SAGAMIHARA-SHI (JP); KAZUHIKO YAMAZAKI, HIRATSHUKA-SHI (JP)

Correspondence Address: R STRIMAITIS, IBM CORPORATION, INTELLECTUAL PROPERTY LAW DNGA J2B, 650 HARRY ROAD, SAN JOSE, CA, 951206099

(21) Appl. No.: 09/127,235

(22) Filed: Jul. 31, 1998

(30) Foreign Application Priority Data
Apr. 9, 1997 (JP) 9-240033

(51) Int. Cl. G09G 5/00

(52) U.S. Cl. 345/168

(57) ABSTRACT

An embedded keyboard pointing device is provided to a laptop computer having a TrackPoint device, with an additional input section corresponding to a third button. Keys are arranged in the “QWERTY” key configuration on a keyboard unit. A lever shaped TrackPoint is embedded at a position corresponding to the home position on the keyboard. A palm rest is provided forward of the space bar positioned at the center front of the keyboard, and the first and the second buttons are disposed in the center in front of the space bar. A third button is disposed in front of the first and second buttons, with substantially no intervening gap. The third button has a width equal to the sum of the widths of the first and the second buttons. The first to third buttons have protrusions, at the center of their front edges, that a user can engage with his or her fingers. The protrusion on the third button is so formed that it is lower than the protrusions on the first and second buttons.

### TECHNICAL FIELD

The present invention relates to a pointing device for providing a pointing function for a computer system keyboard unit, and in particular to an embedded keyboard pointing device that is primarily used for a notebook computer. More specifically, the present invention relates to an embedded keyboard pointing device that has an additional input function, a keyboard unit, and an information processing apparatus.

### BACKGROUND OF THE INVENTION

Various types of personal computers (PCs), such as desktops, towers and notebooks, are being produced and marketed. Because of the enhancement of the processing capabilities of CPUs (Central Processing Units) and the improvement of video subsystems, it has become common for current PCs to include a bit map display function, i.e., a function for the drawing of individual pixels on a display. In such a hardware environment, the operating system (OS) that is usually loaded can support a bitmapped display and can provide multiple windows.

The latest OSs, such as “OS/2,” from IBM Corp. (“OS/2” is a trademark of IBM Corp.), and “Windows95,” from Microsoft Corp., have graphical user interfaces (GUIs) installed. A computer system that provides a GUI environment generally permits the installation of an input device, such as a mouse, that can be used to designate coordinates. With the mouse, a user can operate a computer system as though he or she were issuing instructions directly to the screen.

A pointing device has two basic functions: one is the two-dimensional moving of a cursor (mouse cursor) on a display screen, and the other is a clicking function that is used for one type of selection operation.

Present on a display screen in a GUI environment, i.e., on a “desktop,” are many object symbols, such as icons and folders. A user can move a cursor on the desktop to a desired icon or folder by using a mouse, and can select an object symbol at the current location of the cursor by clicking a mouse button. When, for example, an icon associated with a specific application is selected, the application is activated, while when a folder is selected, it is opened on the desktop. Further, when a cursor is moved from a specific object symbol to another while the mouse button is held down, and the mouse button is thereafter released, i.e., when a “drag and drop” operation is performed, the moving/copying or erasure of the object symbol can be performed. In other words, in a GUI environment, a user can easily and directly enter his or her desired data merely by intuitively operating the mouse cursor while watching the screen. That is, since the user can perform almost all computer operations merely by manipulating the mouse, he or she is required neither to remember many OS commands nor to study the operation of a keyboard, as is required when using a conventional CUI (Character User Interface) environment.

The mouse generally includes a mouse body that a user grasps, two buttons provided on the top of the body, and a rotatable ball installed at the bottom. The rotation of the ball is, for example, optically read, the rotational direction and the rotational distance of the ball are encoded, and the resultant data are output as a displacement along the x and y axes. The left button is mainly allocated for the selection of objects, and the right button is mainly allocated for shortcut functions. At a cycle of several tens of msec, the mouse transmits to the system a detected value concerning the operating state of the ball or the mouse button. Ordinarily, the mouse is connected by a cable to a mouse port (e.g., a PS/2 mouse port) or a serial port, provided on the wall of the computer.

Although the mouse is already established as pointing device, because the mouse is connected by cables to computers, it is not suitable for portable computers, such as notebook computers. Embedded keyboard pointing devices are normally installed in notebook computers.

A so-called TrackPoint (“TrackPoint” is a trademark of IBM Corp.) conventional embedded keyboard pointing device is illustrated in FIG. 4. The TrackPoint is a small lever input device 40 embedded substantially in the center of a keyboard unit 100 (i.e., centered relative to the “G,” “H,” and “B” keys). A position corresponding to the operating point for the lever is enclosed in four directions by pressure sensors. When a user presses against the distal end (force point) of the lever with a finger, the pressure direction and force are detected by the individual sensors, and a signal equivalent to the displacement of the mouse ball is generated in accordance with the outputs of the sensors. Two buttons 10 and 20 that correspond to the right and the left buttons of a mouse are provided at a palm rest portion 50 at the front of the keyboard unit 100 (in front of the space bar 51) on which the TrackPoint is mounted (see FIG. 4).

Since one feature of the TrackPoint is that only a small mounting/operating area is required, and a user can manipulate the TrackPoint without removing his or her hands from their home positions on the keyboard, it is especially convenient for the execution of software that requires keyboard input. Details concerning the TrackPoint are given, for example, in U.S. Pat. No. 5,521,596 and No. 5,579,033. All of the notebook products in the “IBM ThinkPad” (“ThinkPad” is a trademark of IBM Corp.) series, which are currently being sold by IBM Japan Ltd., have adopted the use of TrackPoint.

A mouse employed for a general purpose personal computers (PCs) usually has two mouse buttons. A mouse having a third (middle) button, in addition to the usual two buttons, has been adopted for use with UNIX. Recently, a mouse having a button corresponding to such a third button has appeared for PCs. An example of a recent mouse 60, “IntelliMouse” from Microsoft Corp., is illustrated in FIG. 5 and has a rotary switch 61, called a “wheel” that can be either rotated or depressed and is disposed between two conventional mouse buttons 62 and 63. The wheel can be rotated forward or backward, each one step rotary displacement of the wheel being the equivalent of a click, and a number of steps (e.g., 18 steps) constituting a complete revolution. A third mouse button can be emulated by depressing the wheel.

The wheel 61 of the mouse can be allocated for a function other than those of the conventional two buttons. For example, merely by rotating the wheel 61 of the IntelliMouse 60 forward or backward, it is possible to scroll a document on a screen (a one step rotary displacement of the wheel corresponds to the scrolling of three lines). Since it is not necessary for the mouse cursor to be moved to the scrolling bar at the window's circumferential edge, a user can easily scroll the screen without removing his or her eyes from the document. When the mouse is moved while the wheel 61 is being depressed like a button and held, ball 64 is rotated, and the document can be sequentially scrolled at a desired speed and in a desired direction. This function is called “panning” or “sequential scrolling,” and when the wheel is released, the scrolling operation is terminated. Because the document is sequentially scrolled without the user removing his or her eyes from the document, a desired portion can be easily found. Further, when the wheel is clicked once and the mouse is moved, the document is automatically scrolled. This function is called “auto scrolling” or the “reading mode.”

According to the “panning” or “auto scrolling” function, a Web browser screen on the Internet can be scrolled immediately simply by manipulating the third button, regardless of the position of the mouse cursor on the screen. The conventional, complicated manipulation employed to move a cursor to a scroll button on the vertical or horizontal scroll bar and then click the mouse button is no longer required.

Another specific function of the IntelliMouse is a “zoom” function by which the display of a document is enlarged/reduced, or a “data zoom” function by which data are folded and hidden, or folded data are reopened and displayed.

It should be noted, however, that special application software is required in order to make the wheel functions available. Software products from Microsoft Corp., such as “Word97,” “Excel97” and “InternetExplorer 3.0,” support the above described unique functions of the IntelliMouse. When application software is used that is not compatible with the use of the wheel, messages generated by the manipulation of the wheel are disregarded, and the IntelliMouse functions substantially the same as does a normal “two-button mouse.”

There is a demand for the provision of the “panning” or “zooming” function for the previously described embedded keyboard pointing device. To respond to this demand, a new input section corresponding to the third button must be provided in addition to the use for the conventional buttons. A new input section can be implemented by a combination of a conventional key, such as the “Shift” or the “Ctrl” key, and a TrackPoint, or by the provision of a new device, such as a “wheel.” However, so long as the pointing device is the embedded keyboard type, it is preferable that the pointing device be so installed on a keyboard unit that it does not interfere with other components, such as keys, and that the mounting area be as small as possible. Furthermore, it is important that the manner in which the pointing device is manipulated does not conflict with the key input manipulation and the manipulation of the TrackPoint, with which a user has become familiar.

### SUMMARY OF THE INVENTION

It is an object of the present invention to provide an embedded keyboard pointing device, which is mainly used for a notebook computer, that includes an input function associated with the third button of a mouse, a keyboard unit and an information processing apparatus.

To achieve the above objects, according to a first aspect of the present invention, an embedded keyboard pointing device comprises: a pointing portion having a lever shape embedded in an appropriate position in keys arranged on a keyboard unit; adjacently disposed first and second buttons positioned substantially at the center of a palm rest on the keyboard unit; and a third button disposed in front of the first and the second buttons.

According to a second aspect of the present invention, an embedded keyboard pointing device comprises: a pointing portion having a lever shape embedded in a position enclosed by keys “G,” “H” and “B” on a keyboard unit having a QWERTY key configuration; adjacently disposed first and second buttons positioned substantially in the center in front of a space bar; and a third button disposed in front of the first and the second buttons.

According to a third aspect of the present invention, a keyboard unit comprises: a plurality of keys arranged on a top face; a palm rest provided in front of an area in which the keys are arranged; a pointing portion having a lever shape embedded at an appropriate location in a key arrangement; adjacently disposed first and second buttons positioned substantially at the center of the palm rest; and a third button disposed in front of the first and the second buttons.

According to a fourth aspect of the present invention, a keyboard unit comprises: a plurality of keys arranged on a top face in a QWERTY key configuration; a pointing portion having a lever shape embedded in a location enclosed by keys “G,” “H” and “B”; adjacently disposed first and second buttons positioned substantially at the center in front of a space bar; and a third button disposed in front of the first and the second buttons.

According to a fifth aspect of the present invention, an information processing apparatus comprises: an apparatus body on the top face of which is mounted a keyboard unit having a plurality of keys; a lid rotatably supported at a rear edge of the apparatus body; a display unit embedded in the surface of the lid; a palm rest provided in front of an area wherein the keys of the keyboard unit are arranged; a pointing portion having a lever shape embedded at an appropriate location in a key arrangement; adjacently disposed first and second buttons positioned substantially at the center of the palm rest; and a third button disposed in front of the first and the second buttons.

According to a sixth aspect of the present invention, an information processing apparatus comprises: an apparatus body on the top face of which is mounted a keyboard unit having a plurality of keys arranged in a QWERTY key configuration; a lid supported rotatably at a rear edge of the apparatus body; a display unit embedded in the surface of the lid; a palm rest provided in front of a space bar; a pointing portion having a lever shape embedded in a location enclosed by keys “G,” “H” and “B”; adjacently disposed first and second buttons positioned substantially at the center in front of a space bar; and a third button disposed in front of the first and the second buttons.

The width of the third button may be substantially equal to the sum of the widths of the first and second buttons.

The first to third buttons may have protrusions, at the center of their front edges, that a user may engage with his or her fingers.

The first to third buttons may have protrusions, at the center of their front edges, that a user may engage with his or her fingers, and the protrusion on the third button may be formed so that it is lower than the protrusions on the first and second buttons.

The embedded keyboard pointing device according to the present invention may be provided with an additional input section corresponding to a third button by using the previously described “TrackPoint” as a base. This is possible because the TrackPoint is superior in its installation and manipulation, to the extent that only a small mounting space is required for the TrackPoint, and a user can manipulate the TrackPoint without removing his or her hands from their home positions on the keyboard. Also, this is possible because the TrackPoint has been established as an embedded keyboard pointing device for a notebook computer.

Generally, keys are arranged in the “QWERTY” key configuration on a keyboard unit. A lever shaped TrackPoint is embedded at a position corresponding to the home position on the keyboard, i.e., a position enclosed by the keys “G,” “H” and “B.”

A palm rest is provided forward of the space bar positioned at the center front of the keyboard, and the first and the second buttons are disposed in the center in front of the space bar. Functions corresponding to those of the right and left buttons of a mouse are allocated to the first and the second buttons.

In addition, a third button is disposed in juxtaposed relationship in front of the first and second buttons, with substantially no intervening gap. It is preferable that the third button have a width equal to the sum of the widths of the first and the second buttons.

On the first and the second buttons are protrusions, formed at the centers of their front edges, that a user can engage them with his or her fingers (well known). A protrusion is also formed on the third button, on its center front edge, that a user can engage with his or her finger. It should be noted that preferably the protrusion on the third button is so formed that it is lower than the protrusions on the first and second buttons.

Since the third button is disposed in front of the first and the second buttons, and has a width equal to the sum of widths of the first and the second buttons, the third button can be manipulated by either thumb. In other words, the third button provides the same ease of usability for a right-handed or left-handed user.

Since the third button is provided in front of the first and the second buttons with no intervening gap, a user can manipulate the third button without removing his or her hands from their home positions, as well as operating the first and the second buttons. The first, the second and the third buttons can be manipulated by using both hands at the same time. A new application can be allocated for the simultaneous manipulation of the buttons.

The third button, as well as the first and the second buttons, is assembled as a part of the keyboard unit, and does not require additional space, so that there is no deterioration of the degree of freedom available with the design.

Since the third button is provided at such a location that a user would have to make a special effort to manipulate it, i.e., it is disposed in front of the first and the second buttons, the presence of the third button does not cause any problems for a user who does not need the third button. And since the protrusion on the third button is formed lower than those of the first and the second buttons, there is very little possibility that a user will unconsciously and erroneously manipulate it. That is, the third button does not interfere with the employment of the conventional keyboard keys.

It should be fully understood that, as far as the embedded keyboard pointing device, the keyboard unit, and the information processing apparatus according to the present invention are concerned, the third button can be added without any deterioration of the superior usability of the TrackPoint, a device that has received high evaluations from users.

For a fuller understanding of the present invention, reference should be made to the following detailed description taken in conjunction with the accompanying drawings.

### BRIEF DESCRIPTION OF THE DRAWINGS

FIG. 1 is a top view of a keyboard unit on which is mounted an embedded keyboard pointing device according to the present invention;

FIG. 2 is a perspective view of the external appearance of a notebook computer on which the keyboard unit of FIG. 1 is mounted;

FIG. 3 is a side cross-section view of a portion of the keyboard unit of FIG. 1;

FIG. 4 is a diagram illustrating the external appearance of a prior art keyboard unit on which a TrackPoint is mounted; and

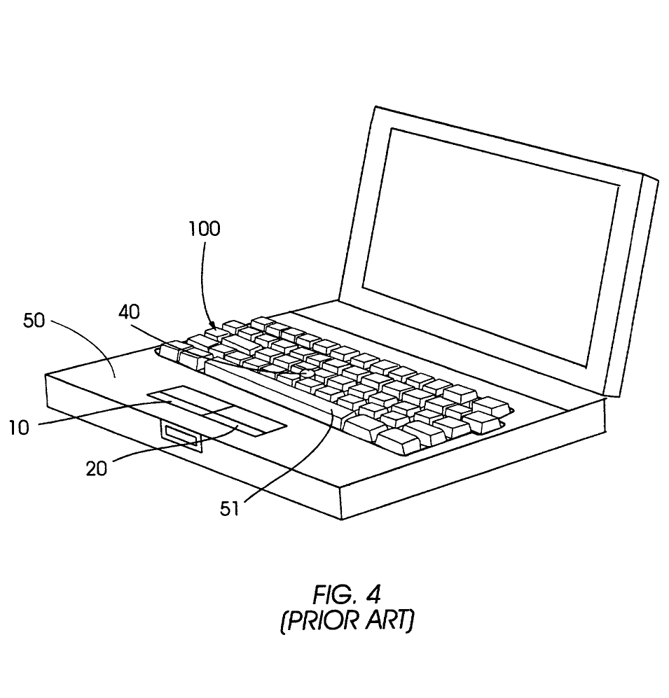

FIG. 5 is a diagram illustrating the external appearance of the prior art “IntelliMouse” from Microsoft Corp.

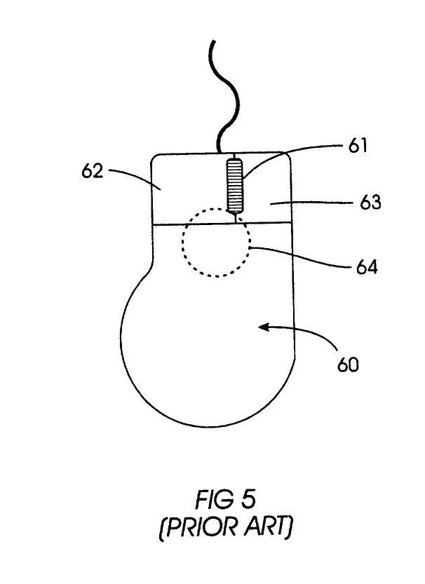

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

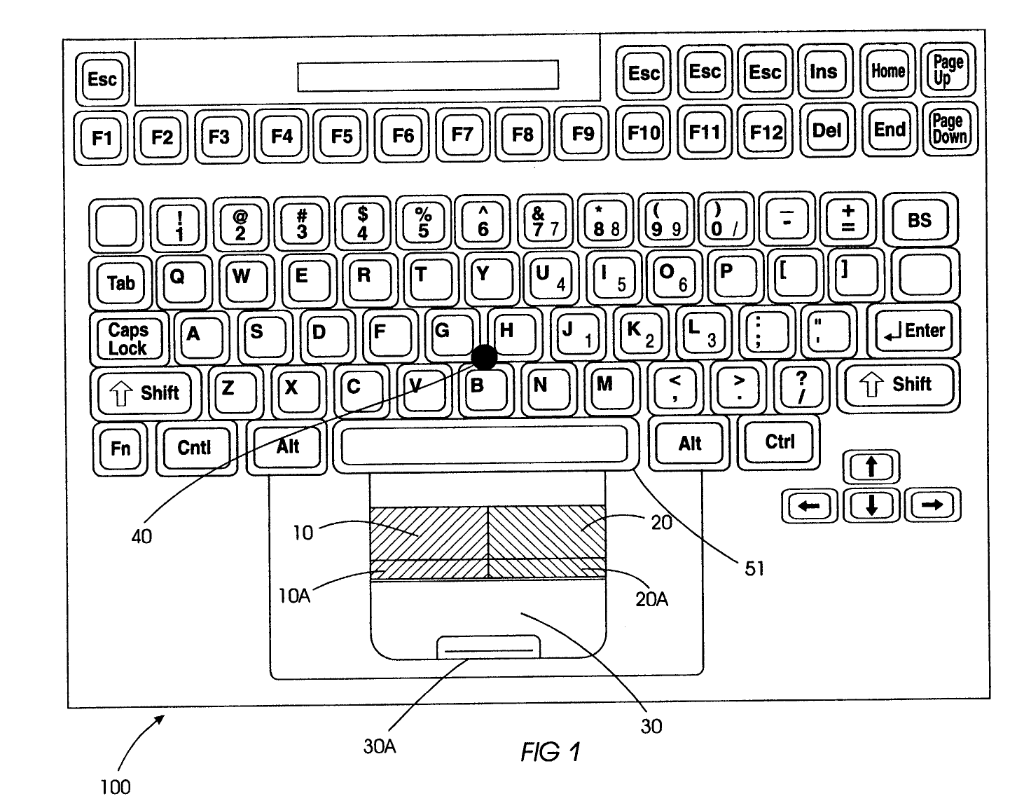

FIG. 1 is a top view of a keyboard unit 100 on which is mounted an embedded keyboard pointing device according to the present invention.

The embedded keyboard pointing device has an additional input section corresponding to a third button 30 provided by using the previously described “TrackPoint” as a base. This is possible because the installation and the usability of the TrackPoint are known, as described above, and the TrackPoint has been well established as an embedded keyboard pointing device for a notebook computer.

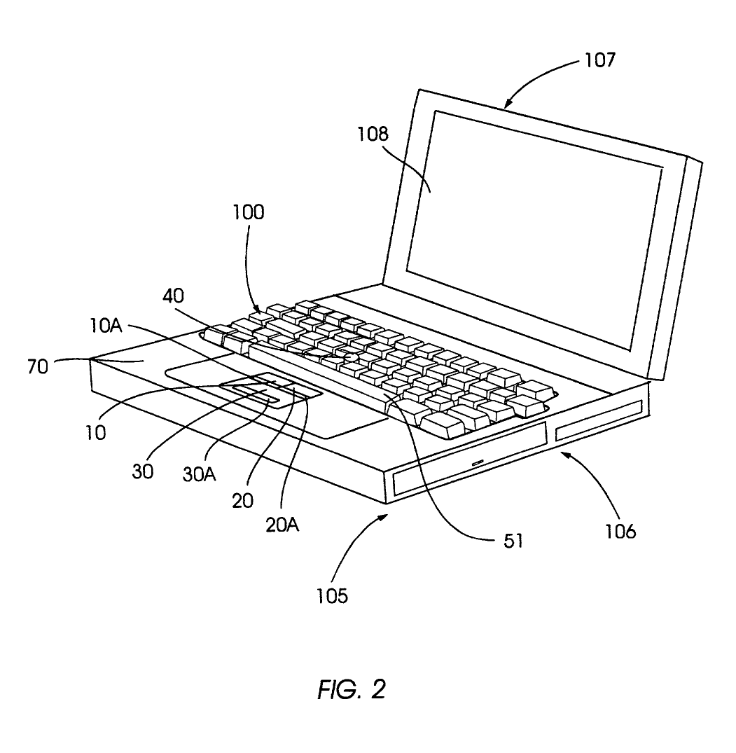

Referring additionally to FIG. 2, the keyboard unit 100 is disposed on the top face of a notebook computer 105. The notebook computer incorporates a motherboard, on which a CPU, a memory and a peripheral controller chip are mounted; and peripheral devices, such as a hard disk drive (HDD), a floppy disk drive (FDD) and a CD-ROM drive (none of them shown) mounted in the main body 106 of the notebook computer 105. A lid 107 is rotatably supported at the rear edge of the computer main body 106. A liquid crystal display (LCD) unit 108, preferably of greater than ten and smaller than twenty inches is embedded in the lid 107.

Referring to FIGS. 1 and 2, alphanumerical keys are arranged in a so-called “QWERTY” configuration on the keyboard unit 100. A TrackPoint 40 having a lever shape is embedded at a position corresponding to the home position of the keyboard, i.e., a position enclosed by keys “G,” “H” and “B.” Pressure sensors (not shown) are attached at the lower end of the lever, which serves as the operating point of the TrackPoint 40, and enclose it from four directions. When a user depresses the top end (force point) of the TrackPoint 40, the sensors detect the pressure direction and the pressure force, and a detection signal equivalent to the displacement of a mouse ball is generated in accordance with the output of the sensors. The user can manipulate the TrackPoint 40 without removing his or her hands from the home positions on the keyboard.

A palm rest 70 is provided forward of the space bar 51 positioned at the center front of the keyboard unit 100. The palm rest is formed flatly to place the hands of the users during the key input operation.

A first button 10 and a second button 20 are provided in the center in front of the space bar. Functions corresponding to those of the two buttons of a mouse are allocated for the first and the second buttons 10 and 20.

A third button 30 is disposed in front of the first and the second buttons 10 and 20, and preferably disposed in juxtaposed relationship thereto with substantially no intervening gap. As is shown in FIG. 1, the third button 30 has a width substantially equal to the sum of the widths of the first and the second buttons 10 and 20.

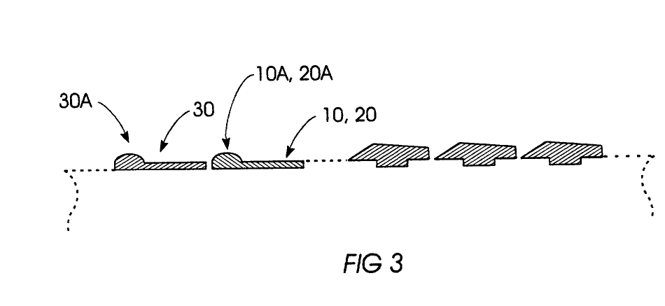

FIG. 3 is a side view of the palm rest of the keyboard unit 100. As is shown in FIG. 3, protrusions 10A and 20A are formed in the center at the front edge of the first and the second buttons 10 and 20, so that user's fingers can engage them while the buttons 10 and 20 are being manipulated (well known). In this embodiment, a protrusion 30A is also formed on the third button 30 so that a user can engage it with his or her finger while the button 30 is being manipulated. The protrusion 30A on the third button 30 is lower than the protrusions 10A and 20A on the first and the second buttons 10 and 20.

Since the third button 30 is disposed in front of the first and the second buttons 10 and 20, and has a width equal to the sum of widths of the first and the second buttons 10 and 20, the third button 30 can be manipulated by either thumb. In other words, the third button 30 provides the same ease of usability for a right-handed or left-handed user.

Since the third button 30 is provided in front of the first and the second buttons 10 and 20 with no intervening gap, a user can manipulate the third button 30 without removing his or her hands from their home positions, as well as operating the first and the second buttons 10 and 20. The first, the second and the third buttons can be manipulated by using both hands at the same time. A new application can be allocated for the simultaneous manipulation of the buttons.

The third button 30, as well as the first and the second buttons 10 and 20, is assembled as a part of the keyboard unit 100, and does not require additional space, so that there is no deterioration of the degree of freedom available with the design.

Since the third button 30 is disposed at a location such that a user would have to make a special effort to manipulate it, i.e., it is disposed in front of the first and the second buttons 10 and 20, the presence of the third button 30 does not cause any problems for a user who does not need the third button 30. And since the protrusion 30A on the third button 30 is formed lower than the protrusions 10A and 20A of the first and the second buttons 10 and 20, there is very little possibility that a user will unconsciously and erroneously manipulate it. That is, the third button 30 does not interfere with the employment of the conventional keyboard keys.

As is described above, according to the present invention, provided is a superior, embedded keyboard pointing device, which is mainly used for a notebook computer, a keyboard unit and an information processing apparatus.

In addition, according to the present invention, provided is an embedded keyboard pointing device that includes an input function associated with the third button of a mouse, a keyboard unit and an information processing apparatus.

It should be fully understood that, as far as the embedded keyboard pointing device, the keyboard unit, and the information processing apparatus according to the present invention are concerned, the third button can be added without any deterioration of the superior usability of the TrackPoint, a device that has received high evaluations from users.

While the preferred embodiments of the present invention have been illustrated in detail, it should be apparent that modifications and adaptations to those embodiments may occur to one skilled in the art without departing from the scope of the present invention as set forth in the following claims.

We claim:

1. An embedded keyboard pointing device comprising:
a pointing portion having a lever shape embedded in keys arranged on a keyboard unit;
adjacently disposed first and second buttons positioned substantially at the center of a palm rest on said keyboard unit; and
a third button disposed in front of said first and said second buttons.

2. An embedded keyboard pointing device comprising:
a pointing portion having a lever shape embedded in a position enclosed by keys “G,” “H” and “B” on a keyboard unit having a QWERTY key configuration including a space bar;
adjacently disposed first and second buttons positioned substantially in the center in front of said space bar; and
a third button disposed in front of said first and said second buttons.

3. The embedded keyboard pointing device according to claim 2, wherein the width of said third button is substantially equal to the sum of the widths of said first and second buttons.

4. The embedded keyboard pointing device according to claim 2, wherein said first to third buttons additionally comprise protrusions, at the center at the front edges thereof, for engagement by a user.

5. The embedded keyboard pointing device according to claim 4, wherein said protrusion on said third button is lower than said protrusions on said first and second buttons.

6. A keyboard unit comprising:
a plurality of keys arranged on a top face;
a palm rest provided in front of an area in which said keys are arranged;
a pointing portion having a lever shape embedded in said key arrangement;
adjacently disposed first and second buttons positioned substantially at the center of said palm rest; and
a third button disposed in front of said first and said second buttons.

7. A keyboard unit comprising:
a plurality of keys arranged on a top face in a QWERTY key configuration including a space bar;
a pointing portion having a lever shape embedded in a location enclosed by keys “G,” “H” and “B”;
adjacently disposed first and second buttons positioned substantially at the center in front of said space bar of said plurality of keys; and
a third button disposed in front of said first and said second buttons.

8. The keyboard unit according to claim 7, wherein the width of said third button is substantially equal to the sum of the widths of said first and second buttons.

9. The keyboard unit according to claim 7, wherein said first to third buttons additionally comprise protrusions, at the center at front edges thereof, for engagement by a user.

10. The keyboard unit according to claim 9, wherein said protrusion on said third button is lower than said protrusions on said first and second buttons.

11. An information processing apparatus comprising:
an apparatus body on the top face of which is mounted a keyboard unit having a plurality of keys;
a lid rotatably supported at a rear edge of said apparatus body;
a display unit embedded in the surface of said lid;
a palm rest provided in front of an area wherein said keys of said keyboard unit are arranged;
a pointing portion having a lever shape embedded in said plurality of keys;
adjacently disposed first and second buttons positioned substantially at the center of said palm rest; and
a third button disposed in front of said first and said second buttons.

12. An information processing apparatus comprising:
an apparatus body on the top face of which is mounted a keyboard unit having a plurality of keys arranged in a QWERTY key configuration including a space bar;
a lid rotatably supported at a rear edge of said apparatus body;
a display unit embedded in the surface of said lid;
a palm rest provided in front of said space bar of said plurality of keys;
a pointing portion having a lever shape embedded in said plurality of keys at a location enclosed by keys “G,” “H” and “B”;
adjacently disposed first and second buttons positioned substantially at the center in front of said space bar; and
a third button disposed in front of said first and said second buttons.

13. The information processing apparatus according to claim 12, wherein the width of said third button is substantially equal to the sum of the widths of said first and second buttons.

14. The information processing apparatus according to claim 12, wherein said first to third buttons additionally comprise protrusions, at the center at front edges thereof, for engagement by a user.

15. The information processing apparatus according to claim 12, wherein said protrusion on said third button is lower than said protrusions on said first and second buttons.
